(19) United States
(12) Patent Application Publication
(10) Pub. No.: US 2024/0110775 A1
(43) Pub. Date: Apr. 4, 2024

(54) WRITEABLE AND ERASABLE ARTISAN RULES

(71) Applicant: Russel Dian, New York, NY (US)

(72) Inventor: Russel Dian, New York, NY (US)

(21) Appl. No.: 18/478,985

(22) Filed: Sep. 29, 2023

Related U.S. Application Data
(60) Provisional application No. 63/377,557, filed on Sep. 29, 2022.

(51) Int. Cl. G01B 3/04; B32B 27/08; B32B 27/32; B43L 1/00; G01B 3/00

(52) U.S. Cl. CPC G01B 3/04; B32B 27/08; B32B 27/32; B43L 1/00; G01B 3/002; B32B 2307/412; B32B 2307/414; B32B 2405/00; G01B 3/566

(57) ABSTRACT

A ruler, steel square, combination square, try square, or the like has a surface partially or entirely covered with a polymeric film. The polymeric film has a writing surface upon which legible and erasable markings may be made with a standard graphite- or wax-based pencil.

### RELATED APPLICATIONS

This application claims priority of U.S. provisional application No. 63/377,557 filed on Sep. 29, 2022, which is incorporated herein by reference in its entirety.

### FIELD OF THE INVENTION

This invention relates to artisans' measuring tools, and in particular to rulers, miter squares, T-squares, steel squares and combination squares having erasable writing surfaces.

### BACKGROUND

The steel square, also known as the “carpenter's square” or “framing square”, has long been used by craftsmen to lay out stone and wooden structures that require right angles, such as walls, rafters, door and window frames, and stairs. Wooden versions were used in antiquity to lay out the Pyramids. Although modern examples may be made from aluminum or brass as well as from stainless steel, the name “steel square” remains in use today regardless of the actual metal used.

A typical steel square is an L-shaped rule consisting of a long, wide arm and a shorter, narrower arm, which meet at an angle of 90 degrees. The longer, wider arm (the blade or body) is typically two inches wide, while the shorter, narrower arm (the tongue) is typically one and a half inches wide. Thicknesses are on the order of 1/16 to ⅛ of an inch for stainless steel or aluminum examples. Printed or engraved indicia provide linear measuring scales, and in professional-grade examples, additional useful scales such as a diagonal scale, board foot scale and octagonal scale, along with pitch tables, decimal conversion tables, rafter tables, and the like, may be disposed on the surface of the square. U.S. Pat. No. 7,958,645 to Chappell, and No. 10,538,125 to Smith, present examples of the types of indicia that may be present. Electronic calculators have largely supplanted the use of such tables and scales, which are understood and routinely used by only a small fraction of today's artisans, and these sophisticated scales have largely disappeared from the market.

The combination square is a related, multi-purpose measuring and marking tool, used in metalworking, woodworking, and stonemasonry. It comprises a fixed ruled blade with engraved and/or inked graduations, and one or more interchangeable sliding heads or “anvils” that can be reversibly affixed to the blade and locked in place with a hand-tightened cam or knurled cylinder. In addition to a standard “square head” with fixed 90° and 45° faces, adjustable protractor heads, and centering heads (for use with round stock), can be swapped in as needed. As with steel squares, measuring scales are provided on the fixed blade; these scales are normally engraved or stamped into the surface, so as not to be worn off by the sliding head. A locking bolt in the head engages a groove centered along one surface of the blade, which enables locking the head at any desired position along the blade.

The most common “standard” head, used for marking and testing 90° and 45° angles, provides perpendicular surfaces aligned at precisely those angles to the fixed rule. Protractor heads and center-finder heads, specialized for particular uses, are commonly available for professional-grade examples.

Yet other examples of artisan's squares are the T-square, miter square, and try square, technical tools used by draftsmen and woodworkers as guides for drawing lines and aligning (or checking the alignment of) workpieces. Like the combination square, a T-square comprises a long thin blade and a short, thick head or stock, but the head of a T-square is not movable relative to the blade. A miter square is similar, but with the head having a surface at a 45° angle relative to the blade. A try square is L-shaped, with a stock set at 90° to the blade but having a mitered (45°) edge at the corner. The fence on a table saw can also take the form of a T-square or miter square, and such fences are “squares” for the purposes of this specification.

An artisan employing a square often has the need to temporarily write down a measured or calculated value, in order to transfer that value to some other piece. The artisan may also wish to make other temporary notations that he or she does not want to commit to memory, with the attendant risk of mis-remembering the information when it is needed. A pencil and notepad are the common tools for making such notations, but using a pencil and pad requires setting down both the square and the piece being worked on. It would be far more convenient if the only additional tool were the pencil, and if the surface of the square itself could be used as the writing surface. Artisans often find it desirable to mark off distances directly on a square or ruler, in order to transfer the same distance to another part of the work.

However, the surface of a square is generally not suitable for making pencil marks, as it is normally too smooth to abrade and retain a visible portion of graphite from a pencil tip. The same problem arises when using a so-called “red lead” carpenter pencil, the core of which contains a red pigment in a hard, water-soluble waxy matrix. One can use a softer, wax-based crayon, but the resulting marks are of low resolution, and erasure often requires the use of a solvent. A fine-tipped solvent-based marker pen may be capable of writing on the surface of the square, but here too, erasing the marks usually requires a solvent. These considerations apply equally to artisans' rulers, which are rarely constructed of a material suitable for being reversibly written upon.

There remains an unmet need for artisans' rulers and squares that can be legibly and reversibly written upon with a pencil. The present invention addresses that need by providing rulers and squares having at least a portion of their surface covered by a polymeric film, the film having a writeable and erasable surface.

### SUMMARY OF THE INVENTION

In one embodiment, the invention provides a ruler, steel square or combination square having at least one ruled surface, a portion of which surface is covered with a polymeric film. The polymeric film has a writing surface upon which legible and erasable marking may be made with a standard No. 2 pencil, or with medium graphite or “red lead” carpenter pencils.

In a second embodiment, the invention provides a ruler, steel square or combination square, having a laminated polymeric film covering at least a portion of its surface. The lower layer of the laminate is adhesive on the bottom side, which is in contact with the surface of the ruler or square, and printed on the upper side with the rule indicia and digits ordinarily printed or engraved on rulers. The upper layer of the laminate is polymeric film, also adhesive on its bottom side, which is in contact with the printed surface of the lower laminate layer. The upper side of the upper layer has a writing surface upon which legible and erasable marking may be made with a standard No. 2 pencil, or with medium graphite or “red lead” carpenter pencils.

### BRIEF DESCRIPTION OF THE FIGURES

FIG. 1 is a top view of a steel square having an erasable writing surface disposed on its upper face.

FIG. 2 is a cross-section through the view of FIG. 1, showing an embodiment having a multilayer polymer film.

FIG. 3 is a top view of a combination square having an erasable writing surface disposed on its upper face.

FIG. 4 is a cross-section through the view of FIG. 3, showing an embodiment having a cast film.

FIG. 5 is a top view of a T-square having an erasable writing surface covering the entire blade.

FIG. 6 is a cross-section through the view of FIG. 5, showing an embodiment having a multilayer polymer film.

FIG. 7 is a top view of a try square having an erasable writing surface covering the entire blade.

FIG. 8 is a cross-section through the view of FIG. 7, showing an embodiment having a multilayer polymer film.

FIG. 9 is a photographic top view of a T-square according to the invention, showing erasable marks being used to consistently place drilling locations along the length of a work piece.

### DETAILED DESCRIPTION OF THE INVENTION

For convenience, the terms “square” and “artisan's square” will be used interchangeably herein to refer to steel squares, combination squares, miter squares, rafter or speed squares, try squares and T-squares, and should be understood to include various known variations of these tools. The term “ruler” will refer specifically to a rectangular measuring tool that is not L- or T-shaped, while the term “rule” will refer collectively to both squares and rulers. “Rule indicia” refers to the linear marks, perpendicular to the edges of a rule, which indicate a distance along the rule in inches and fractions thereof, or in centimeters and millimeters. “Writeable” as used herein refers to a surface that can be marked with a black No. 2 pencil and/or with a red carpenter pencil. “Erasable” means that the resulting pencil marks can be substantially or entirely removed by rubbing the surface with a typical pencil eraser.

The present invention provides industry-standard rulers and squares, of any design that artisans may find useful in their work. These items may be made of any suitably rigid material, including but not limited to wood, metals such as steel and aluminum, polymers including but not limited to polyamides, polycarbonates, polyacrylates, polystyrene, ABS, and epoxies, and various copolymers and block copolymers thereof, and composite materials including but not limited to resin-impregnated carbon, glass and aramid fiber fills and fabrics. Rulers may, in addition, take the form low-cost cards formed from flexible plastic sheeting (such as PVC or polyester), laminated paper, or the like, which typically have a thickness of 0.01 to 0.02 inches and range from 3 to 12 inches in length. The invention is a modification of these various rulers and squares, which provides a writeable and erasable polymer film surface. The invention excludes spring-wound flexible tape measures, which are subject to considerable abrasion when deployed and then re-wound.

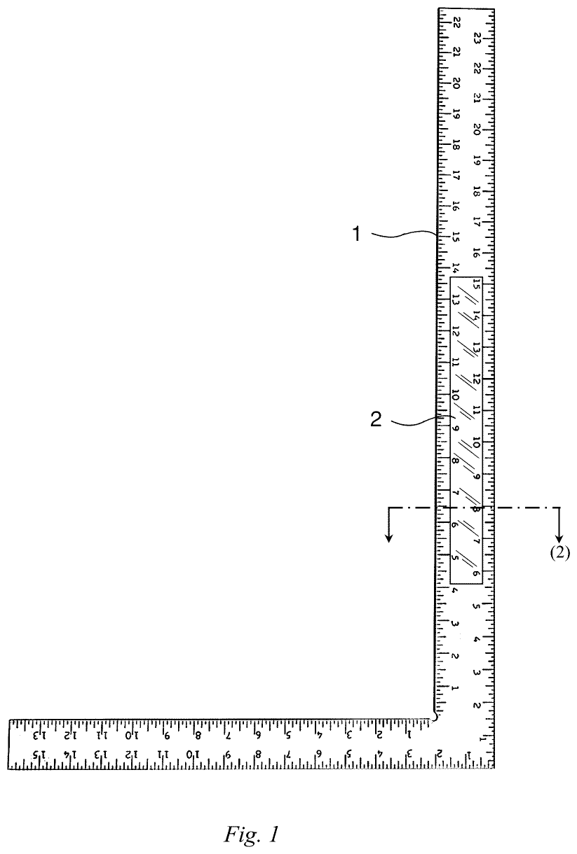

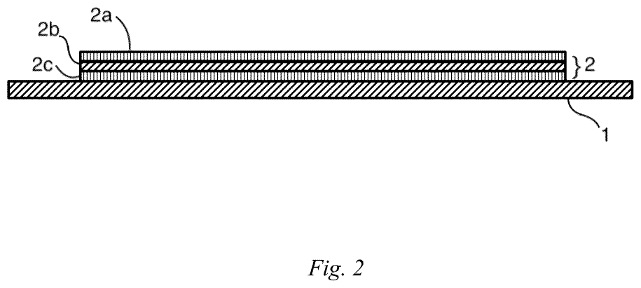

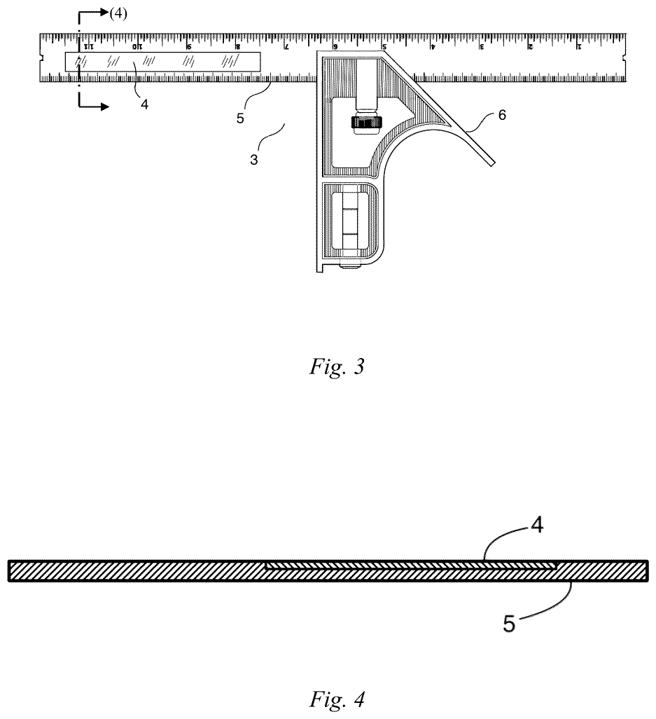

FIG. 1 shows a representative embodiment comprising a steel square 1 having adhered to its ruled surface a writeable polymer film 2. The indicated cross section is shown in FIG. 2. In the embodiment shown in FIG. 2, polymer film 2 comprises a writeable layer 2a, a structural layer 2b, and an adhesive layer 2c. FIG. 3 shows a representative combination square 3 having an adhered polymer film 4. The indicated cross section is shown in FIG. 4. In the embodiment shown, the polymer film 4 is set in a recess in the surface of the blade 5, so as not to interfere with the operation of the movable head 6. The use of a recess is particularly well-suited to embodiments employing cast polymer films.

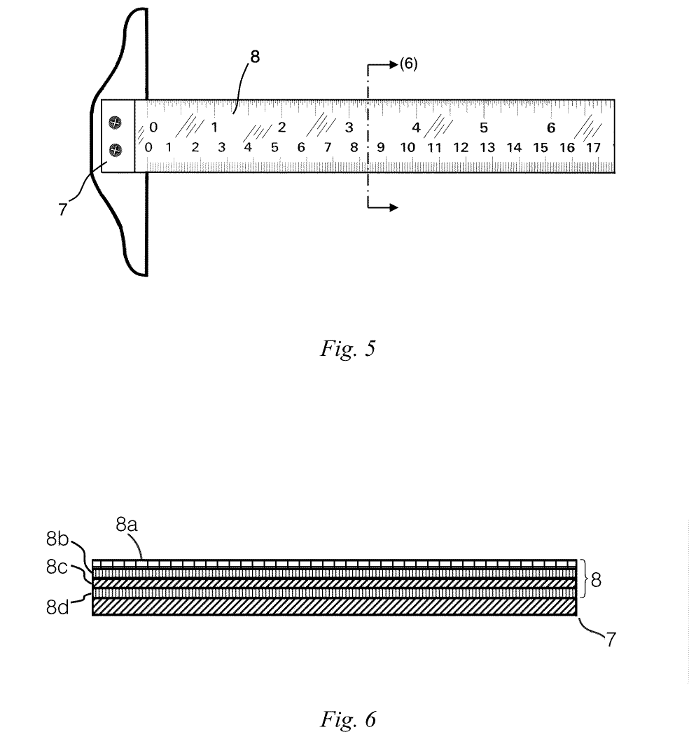

FIG. 5 shows a representative embodiment comprising a T-square having adhered to its blade 7 a writeable polymer film 8 covering substantially the entire blade. The indicated cross section is shown in FIG. 6. In the embodiment shown in FIG. 6, polymer film 8 comprises a writeable layer 8a, a structural layer 8c, and adhesive layers 8b and 8d. The printed indicia shown in FIG. 5 are preferably printed on the structural layer 8c, where they are protected from damage and abrasion by the overlying layers.

It should be understood that the relative thicknesses of the blades and polymer films in FIGS. 2, 4 and 6 are not drawn to scale, but are drawn with proportions that enhance the clarity of the drawings.

The polymer films of the invention can comprise any polymers that are readily cast onto to the surface of a rule so as to form a film, or which can be pre-formed into a film prior to application to the surface. The film may be opaque, and optionally may have indicia printed upon it, or it may be transparent or translucent, so that indicia on the surface of the rule or printed on an intermediate polymer layer that might be overlaid by the film will remain legible.

Film-forming polymers can be applied as a melt, or as a solution or emulsion in a carrier solvent, which evaporates to leave the polymer as a thin film. Alternatively, a pre-polymer composition, comprising monomer species and optionally cross-linkers, can be applied with or without a carrier solvent. Alternatively, powder coating may be employed to distribute solvent-free polymers or pre-polymers as thin films. Polymerization and/or cross-linking in situ can be initiated by methods known in the art, including but not limited to thermal treatment, exposure to atmospheric oxygen or moisture, irradiation with UV or higher-energy electromagnetic radiation, electron beam irradiation, and the like. Solvent evaporation can lead to the fusion and subsequent polymerization of emulsified particles, using known latex-based coating technologies. The term “cast film” is used herein to refer to all of the above-described films, whether or not a solvent is employed.

Certain polymers inherently possess writeable surfaces, due to an appropriate combination of hardness, hydrophilicity, and surface roughness, and such writeable films may be employed in the present invention. Examples are found, for example, in U.S. Pat. No. 4,010,289 to Kobayashi, which is incorporated herein by reference in its entirety. Similarly, matted films are known which comprise a mat layer containing a binder and finely divided inorganic particles. Examples may be found, for example, in U.S. Pat. No. 5,308,693 to Ryle et al., and U.S. Pat. No. 5,316,843 to Kiryu et al., which are incorporated herein by reference in their entireties. Because of the presence of the inorganic particles, the surface of a matted film is slightly roughened, making it writeable with a pencil. Such films may be employed as the writeable films of the present invention, either directly on the surface of the square or as a top layer applied to a base polymer film. These inherently writeable films are effective at receiving markings from most pencils.

As an alternative to the inherently writeable films, the above-described coatings-based polymer films may be generated in the form of smooth-surfaced films, which require a subsequent surface treatment to confer upon them a writeable surface. Known mechanical methods of roughening, e.g. by sandblasting or with an abrasive wheel, belt, or paper may be employed. Other physical and chemical roughing processes, such corona discharge, high temperature treatment; and chemical treatment with agents such as ozone, chlorine, peroxides, and chromates are known in the art, and may also be employed.

A preferred method of roughening is the more economical and faster process of surface embossing. Embossing involves the application to the polymer film, with pressure and heating, of an embossing plate or roller having a particular degree of surface roughness. The pressure, temperature and time are adjusted, as is known in the art, so as to transfer the surface roughness of the embossing surface to the polymer film surface. A surface roughness ranging from 0.3 to 1.5 μm has been found to be satisfactory to confer writeability to a polymer film.

An alternative to a cast film is a pre-formed laminated multilayer film comprising a writeable top surface layer. The writeable layer may consist, for example, of a uniaxially- or biaxially-stretched polyolefin film, where the stretching produces a surface with a degree of roughness that is capable of abrading and retaining pigment or graphite from the tip of a pencil. See, for example, U.S. Pat. Nos. 5,667,872 to Ohno et al. and 5,629,072 to Yamanaka et al., both of which are incorporated herein by reference in their entireties, and the references cited therein. Such laminates further comprise an intermediate base layer to provide mechanical strength, typically a polyolefin such as polypropylene or polyvinyl chloride, or a polyester such as polyethylene terephthalate, and a bottom adhesive layer opposite to the writeable layer. The base layer may be transparent, allowing rule indicia on the rule itself to show through, or it may be filled with an inorganic pigment so as to provide an opaque background for rule indicia that are printed upon it.

Pre-formed writeable films are presently manufactured with hot melt or adhesive backings, suitable for being affixed directly to the surface of an artisan's ruler or square. Suitable examples are the products marketed by the Transcendia company of Franklin Park, Illinois as “CLEAR WRITEABLE MATTE INDEX TABBING FILM 3.0”, “WRITEABLE MATTE”, and TRANS-KOTE™ PET films with a “chemical matte” surface and a carboxylated polyethylene hot melt adhesive backing.

The writeable polymeric film may be installed over only one or two selected portions of the surface of a ruler or steel square, as is shown in FIGS. 1-4. In certain other embodiments the entire surface of a ruler or steel square, or substantially the entire surface of the blade of a combination square or T-square, may be made writeable with the polymeric film, as is shown in FIGS. 5 and 6.

In yet another embodiment of the invention, the rule indicia, that is, the inch or millimeter markings of the rule, are permanently printed on either side of the writeable polymeric film. Any of the many well-established methods of printing on plastic film, including but not limited to inkjet, laser, flexographic, and UV litho printing can be employed for this purpose.

In yet another embodiment, the rule indicia may be printed by such methods on the structural layer beneath the writeable polymeric film. In these embodiments the structural layer is preferably specially-adapted for printing; suitable printable films include but are not limited to those disclosed in U.S. Pat. Nos. 6,025,068 and 6,028,028 and references therein, which are incorporated herein by reference in their entireties. Suitable commercially-available materials include, but are not limited to, the Trans Tear Resistant™ and Proprint™ polypropylene sheets marketed by the Transcendia company of Franklin Park, Illinois, and the Pictorico Pro™ PPF150 white polyester film marketed by Pictorico Co., Ltd. of Tokyo Japan. Structural layers not already provided by the manufacturer with an adhesive layer may be affixed to the rule with a mounting (i.e. double-sided) adhesive film, such as the MHA Multi-Heat Adhesive film marketed by Drytac Corp. of Sandston VA.

A particularly convenient method of manufacture is the insertion of a film carrying the printed indicia into a lamination pouch having an external adhesive layer, thermally laminating the printed film between the pouch layers, and adhering the resulting laminate, suitably trimmed, to the surface of a square. Thermally laminatable films adapted for this purpose are known in the art, for example those disclosed in U.S. Pat. No. 6,153,298 (and references therein), which is incorporated by reference herein in its entirety. The permanent adhesive-backed lamination pouches marketed by Jackson-Hirsh Inc. of Northbrook IL are suitable for this method. In particular, use of an adhesive-backed lamination pouch having a “Write-On” finish, for example the product sold by Jackson-Hirsh and coded ADH9x11-5WM1, can accommodate both printed indicia and a writeable surface to the rulers and squares of the invention.

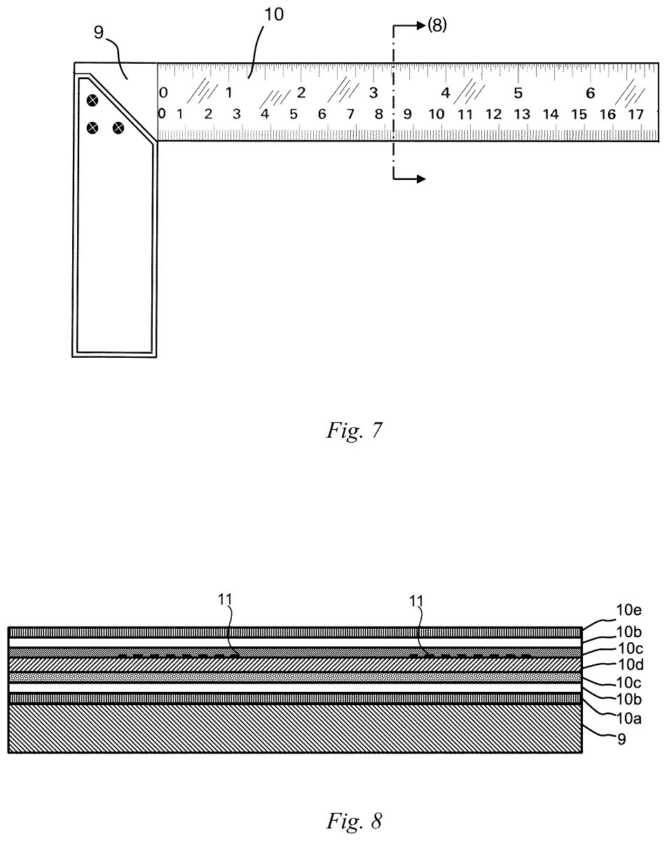

A representative example of this construction is the try square illustrated in FIG. 7. The measuring portion of blade 9 in this example is overlaid with a laminated polymer film 10, with the indicia printed on the structural layer of the film. In cross section, shown in FIG. 8, a printable polyester structural film 10d, bearing the printed indicia 11, is laminated between the layers of a pouch comprising clear base film layers 10b and thermal laminating layers 10c. The base film 10b may be, for example, a polyester such as PET, while the thermal laminating layers 10c are typically a low-melting ethylene vinyl acetate copolymer. The pouch has an adhesive layer 10a disposed on its lower surface, which affixes it to the surface of blade 9, and a writeable/erasable upper surface 10e. Writeable surface 10e may be an applied film, or, as described above, the embossed or chemically-treated surface of layer 10b.

In the above embodiments having rule indicia, it is preferable that the writeable polymeric film extends at least to the straight edge, and more preferably extends over the entire surface of the ruler or blade. It will be appreciated that in addition to the ruler markings, the printed indicia can include marks, charts and tables useful to the artisan; manufacturer's and/or distributor's trademarks; addresses, telephone and internet contact information; promotional and advertising copy; and decorative elements.

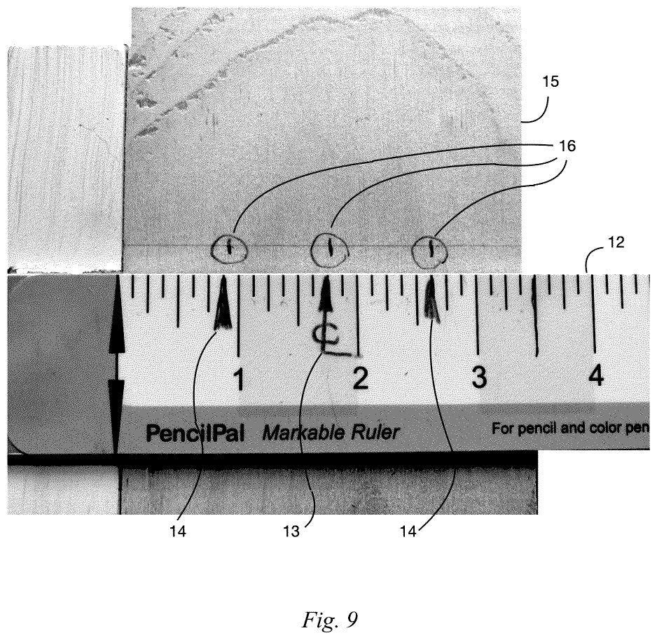

FIG. 9 shows a T-square 12 according to the invention which has been reversibly marked at three points, establishing a center 13 and marks 14 set off ⅞ inch to the left and right. These marks enable the user to quickly mark up work piece 15, and as many identical pieces as needed, in a consistent manner, as shown with markings 16 for the placement of drill holes, nails or screws with little chance of error.

The invention has been described and illustrated with reference to certain preferred embodiments. The drawings and specification illustrate representative embodiments of the invention, and should be understood to represent non-limiting examples. Modifications, substitutions, alterations and equivalents to the embodiments described and illustrated will become apparent to those of ordinary skill upon reading and understanding the preceding description. It is intended that the invention includes all such modifications, substitutions, alterations and equivalents, and that they should fall within the broadly construed scope of the appended claims.

I claim:

1. An artisan's rule, having disposed upon at least one surface a polymeric film, said polymeric film having a writeable and erasable writing surface.

2. The artisan's rule according to claim 1, wherein the polymeric film is a multilayer film.

3. The artisan's rule according to claim 2, wherein the indicia of the rule are printed upon a layer of said multilayer film.

4. The artisan's rule according to claim 1, wherein the rule is a steel square.

5. The artisan's rule according to claim 2, wherein the rule is a steel square.

6. The artisan's rule according to claim 3, wherein the rule is a steel square.

7. The artisan's rule according to claim 1, wherein the rule is a combination square.

8. The artisan's rule according to claim 2, wherein the rule is a combination square.

9. The artisan's rule according to claim 3, wherein the rule is a combination square.

10. The artisan's rule according to claim 1, wherein the rule is a T-square.

11. The artisan's rule according to claim 2, wherein the rule is a T-square.

12. The artisan's rule according to claim 3, wherein the rule is a T-square.

13. The artisan's rule according to claim 1, wherein the rule is a miter square.

14. The artisan's rule according to claim 2, wherein the rule is a miter square.

15. The artisan's rule according to claim 3, wherein the rule is a miter square.

16. The artisan's rule according to claim 2, wherein the pre-formed multilayer film is an adhesive multilayer film.

17. The artisan's rule according to claim 5, wherein the pre-formed multilayer film is an adhesive multilayer film.

18. The artisan's rule according to claim 8, wherein the pre-formed multilayer film is an adhesive multilayer film.

19. The artisan's rule according to claim 1, wherein the rule is formed from metal.

20. The artisan's rule according to claim 1, wherein the rule is formed from a polymer.

21. The artisan's rule according to claim 2, wherein the rule is formed from wood.
